(19) United States
(12) Patent Application Publication
(10) Pub. No.: US 2007/0022508 A1
(43) Pub. Date: Feb. 1, 2007

(54) Altitude protection device

(76) Inventors: Wendelin Egli, Seuzach (CH); Andreas Reinhard, Zurich (CH); Reinhard Wulf, Hamburg (DE); Dirk Schmieding, Ellerbeck (DE)

Correspondence Address: JENKENS & GILCHRIST, PC, 1445 ROSS AVENUE, SUITE 3200, DALLAS, TX, 75202, US

(21) Appl. No.: 10/575,393

(22) PCT Filed: Oct. 19, 2004
(86) PCT No.: PCT/CH04/00630

§ 371 Date: May 19, 2006

(30) Foreign Application Priority Data
Oct. 22, 2003 (CH) 1798/03

(51) Int. Cl. B64D 10/00

(52) U.S. Cl. 2/2.14

(57) ABSTRACT

The invention relates to a device for protecting pilots and other crew members of high-performance aircrafts, especially people wearing pressure suits (1) according to the hydrostatic principle with veins (6) filled with liquid. Said device consists of a tension pocket (2) located in the region of the back and a pressure pocket (3) located in the abdominal region, airtight bladders (4) being inserted into both pockets. Said bladders (4) contain woven spacer elements (5) defining a minimum air volume in the bladders (4). In the event of falling ambient pressure, the pressure pocket (3) first expands and supports the breathing of the person wearing the device by means of pressure on the viscera, when pressure respiration appliances are used. If the ambient pressure falls further, the tension pocket (2) inflates and increases the peripheral tension in the pressure suit (1). In this way, for example, a decompression syndrome can be counteracted in the event of a sudden pressure drop in the cabin at high altitude.

The present invention relates to a device for providing altitude protection to pilots and other members of the crew of high-performance aircraft, according to the precharacterising part of claim 1. In particular, this device to provide altitude protection relates to wearers of acceleration protection suits that function according to the hydrostatic principle.

An altitude protection device is necessary when the pilot and any other crew members are exposed to sudden loss of pressure in the cockpit of an aircraft flying at an altitude in excess of 12,200 metres above sea level (FL400=flight level 40,000 ft). Be it that a technical defect has led to the loss of pressure, that the cockpit cover has been destroyed or lost, or that emergency ejection has become necessary, in all these situations pressure stabilisation in the cockpit, which normally corresponds to an air pressure at approximately 2,000 metres above sea level (FL65), collapses. The higher the flight altitude during such an event as mentioned, the closer the pressure-dependent boiling point of aqueous solutions approaches the actual body temperature of approximately 37° C. of the pilot. Apart from gases, which expand in the intestines, and apart from decompression illness, which occurs despite rapid descent, the primary acute danger against which measures have to be taken is, however, posed by hypoxemia, i.e. oxygen deficiency. Even when breathing-in pure oxygen, at altitudes above 12,200 metres above sea level (FL400) the O2 partial pressure is no longer sufficient to prevent hypoxemia. At this altitude, the time span during which consciousness permits useful actions is approximately 1.5 to 20 minutes, while 1000 m higher up, at an altitude of 13,100 metres above sea level (FL430) this time span is only 9 to 12 s. In order to counter the threat of hypoxemia, it is possible to breath pure oxygen, if need be even at a pressure that is higher than the ambient pressure. In this context the term “pressure breathing for altitude protection” (PBA) is used, in contrast to the newer “positive pressure breathing” (PPB). At an altitude in excess of 15,200 metres above sea level (FL500) pressure breathing is of little value because it is physiologically impossible to withstand the necessary positive pressure to prevent severe hypoxemia without the presence of counter pressure. This is the reason why at the very latest from this flight altitude persons must be equipped with a pressure suit or altitude protection, which in the case of a sudden loss of pressure in the cabin immediately provides increased pressurisation to the body.

WO 03/020586 discloses an altitude protection device that is integrated in an acceleration protection suit according to the hydrostatic principle and, during sudden loss of pressure, pressurises the body of the wearer by increasing circumferential tension. The present application represents the next state of the art.

The above-mentioned application uses a valve which during sudden large changes in pressure closes immediately. Such a component is expensive, requires considerable maintenance effort to ensure its proper function and still increases the susceptibility to trouble of the entire altitude protection device. This device with a valve is also associated with the characteristics that in the case of an accident the protection function has to be activated and is not a permanent feature from takeoff right through to landing. During a slow continuous loss of pressure due to a minor leak in the envelope of the pressurised cabin, a valve that only reacts to quick changes in pressure will for example not close, and altitude protection will have to be activated manually or by some other system.

It is the object of the present invention to create a supplementary device for an acceleration protection suit (hereinafter G-suit) which device in conjunction with said G-suit is able to provide effective altitude protection in the above-mentioned cases in connection with an insignificant increase in the dimensions of the G-suit. Furthermore, the technical and economic effort for this is to be as small as possible; in particular there should be no need for any valves or other technical devices to activate the protection function at the moment when loss of pressure occurs.

This object is met as set out in the characterising part of claim 1 in relation to its essential characteristics, and in the further claims in relation to further advantageous exemplary embodiments.

The subject matter of the invention is explained in more detail by means of the enclosed drawings.

The following are shown:

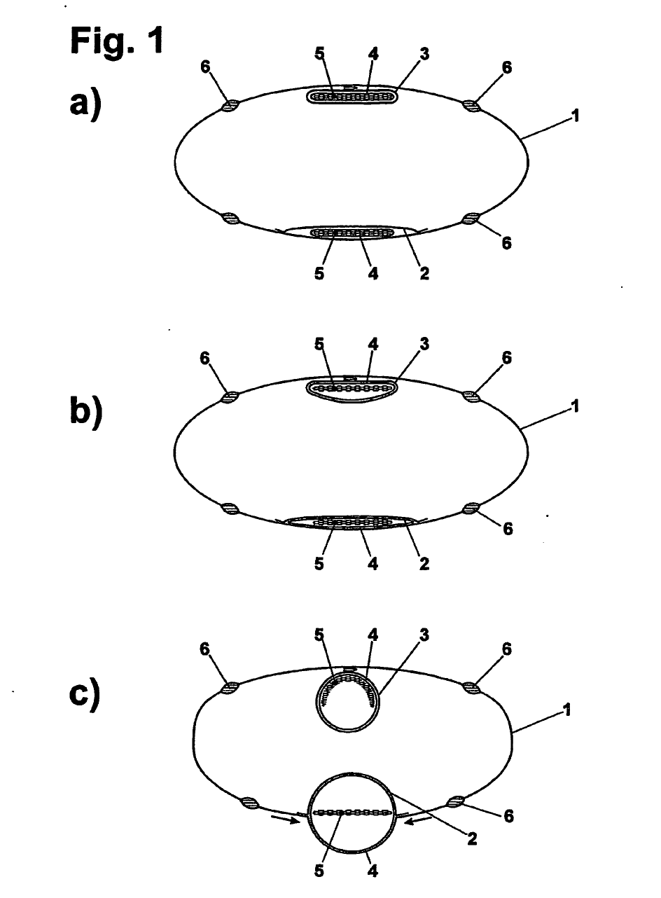

FIG. 1a diagrammatic representations of a first exemplary embodiment in cross section at stomach height, pressurised at sea level;

FIG. 1b diagrammatic representations of a first exemplary embodiment in cross section at stomach height, with the circumferential tension of the G-suit commencing to increase;

FIG. 1c diagrammatic representations of a first exemplary embodiment in cross section at stomach height, at maximum extension of the two bladders;

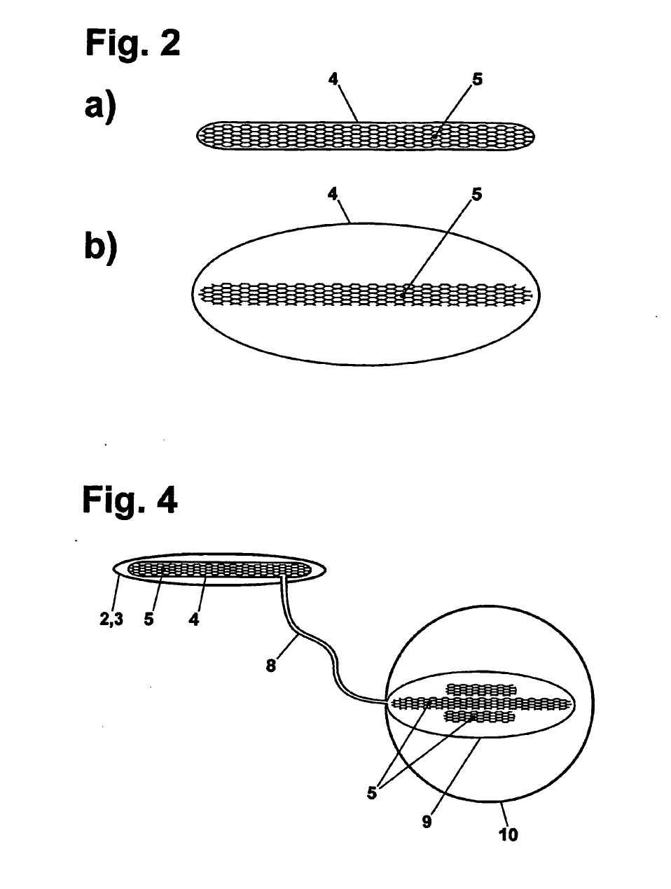

FIG. 2a, b cross sections of a first exemplary embodiment of a bladder in its expanded and relaxed state;

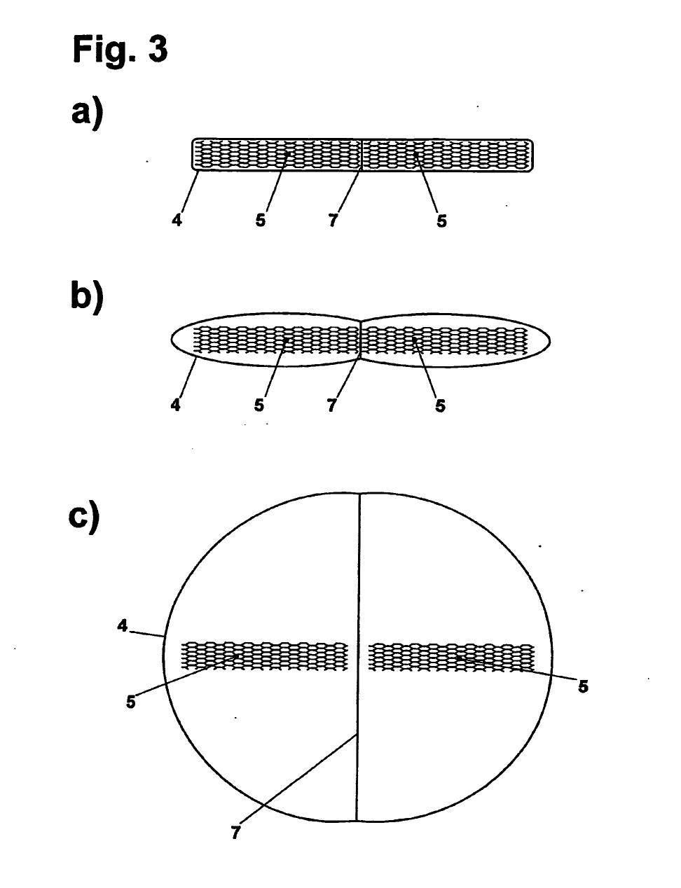

FIG. 3a, b, c cross sections of a second exemplary embodiment of a bladder in its relaxed, expanded and maximum expanded state; and

FIG. 4 a cross section of a third exemplary embodiment of a bladder with an additional gas reservoir.

FIG. 1a, b, c diagrammatically shows a first exemplary embodiment of the inventive idea. It shows a cross section of the stomach region of a G-suit 1 according to the hydrostatic principle, for example according to EP 0 983 190. Said G-suit comprises for example four liquid-filled veins 6, two each on the front and on the rear of the G-suit 1. These veins 6 extend from the shoulder region of the G-suit 1 to the ankles; in each instance they provide the hydrostatic pressure that corresponds to the actual acceleration load. In this arrangement the veins 6 deform from an essentially flat lenticular cross section to a round one and in so doing tension the tension-resistant and stretch-resistant woven fabric of the G-suit 1. By way of the tensile stress which is present in this woven fabric as a result of the aforementioned, external pressure is built up on the body of the wearer, which external pressure corresponds to the internal pressure.

FIG. 1a shows the altitude protection device at atmospheric pressure at sea level. In the first exemplary embodiment shown, a pocket 2 is non-positively attached in the back region of the G-suit 1, for example by sewing, comprising a textile fabric with characteristics that are comparable to those of the G-suit 1. A bladder 4 has been placed in this pocket 2. This bladder 4, made of an elastic plastic material, for example PU or PVC, is closed off on all sides towards the outside. The expansion of the bladder 4 is delimited by the pocket 2. As the pressure in the bladder 4 increases, the pocket 2 gradually assumes its maximum volume with a circular cross section, and consequently the circumferential tension increases as the circumference of the G-suit 1 is shortened. For this reason, for better differentiation, the pocket 2 is hereinafter referred to as the tension pocket 2. The simplest form of a tension pocket 2, as shown in FIG. 1, comprises a piece of woven fabric that lies flat against the inside of the G-suit 1 and that along its edges is sewn to the G-suit 1. In this way part of the G-suit 1 together with the additional piece of woven fabric forms a tension pocket 2. However, it is also imaginable and covered by the invention to attach a closed pocket on the outside or the inside of the G-suit 1 in a non-positive manner. This pocket can be placed flat so that it is only attached by its edges, for example by sewing or gluing, or the entire area resting on the G-suit 1 can be connected to said G-suit.

A pocket 3 is attached to the front of the G-suit 1, to the inside, for example along a line that is perpendicular to the direction of tension, or to some points along this line. Attachment is such that expansion of the bladder 4 on the inside has essentially no influence on the circumferential tension of the G-suit 1, but instead such that an inflated pocket 3 primarily exerts local pressure onto the body in place in the G-suit 1, more precisely to the soft tissue in the abdominal cavity. The pocket 3 is therefore hereinafter referred to as the “pressure pocket” 3. Attachment of the pressure pocket 3 is only used for positioning it in the desired location; attachment has to absorb lesser tension than does attachment to the tension pocket 2. The inventive step includes exemplary embodiments comprising several pressure pockets 3 or tension pockets 2 arranged side by side.

One or several layers of a knitted or woven distance fabric 5 have been placed in both bladders 4, both in the tension pocket 2 and in the pressure pocket 3. Such knitted distance fabrics 5—at least partially made of monofilament material—are very flexible and deformable and maintain their thickness even when subjected to loads per surface unit. The size and thickness of the knitted distance fabric 5 defines a minimum volume in the bladder 4, which minimum volume is taken up by the relaxed bladder 4 at base altitude, for example altitude at sea level.

Cockpits of fighter aircraft are designed as pressurised cabins. During climbing flight of the aircraft the external pressure is compensated for up to a flight altitude of approximately 2,000 metres above sea level (FL65). Above this altitude the internal pressure is kept constant. An actual altitude protection case occurs if the cabin pressure that corresponds to an atmospheric pressure at FL65 drops to the ambient pressure of the aircraft. This is the case for example
during sudden failure of the cabin pressure supply;
if the pressure cell sustains damage;
in the case of loss or damage to the cockpit cover; or
in the case of an emergency exit by means of the ejection seat.

In such altitude protection cases the airtight bladders 4 expand until the pressure equilibrium with their surroundings is restored. In this process the tension pocket 2 and the pressure pocket 3 have different effects on the organism of the person wearing the G-suit 1.

FIG. 1b shows the altitude protection device at an atmospheric pressure corresponding to an altitude of 5,500 metres above sea level (FL180). At this pressure the bladder 4 in the pressure pocket 3 has approximately twice the volume it does at sea level. Consequently the pressure pocket exerts less of a pressure force onto the abdominal cavity of the wearer and in this way supports pressure breathing. This expansion has no significant influence on the circumferential tension of the G-suit 1.

At this altitude the tension pocket 2 on the back of the G-suit 1 is just about filled. The expansion of the bladder 4 placed in said tension pocket 2 also leads to a small increase in pressure in the interior of the G-suit 1, but it does not yet lead to a significant increase in the circumferential tension of the G-suit. When the environmental pressure is further reduced the tension pocket 2 with the bladder 4 expanding therein acts as a linear actuator whose cross section gradually becomes circular, thus increasing the circumferential tension of the G-suit 1 by shortening the circumference.

FIG. 1c shows the altitude protection device at maximum effect at an atmospheric pressure as encountered at maximum operational altitude of the aircraft, for example at an altitude of 19,800 metres above sea level (FL650). Both bladders 4 completely fill their pockets 2, 3 and are prevented by said pockets 2, 3 from expanding any further, even if the ambient pressure continues to drop.

The altitude stated in this first exemplary embodiment, at which altitude the tension pocket 2 begins to function as an actuator, represents a physiologically sensible example but it is in no way mandatory. In normal operation, at regulated cabin pressure, the member of the crew is not to be impeded by the altitude protection device and is to have full mobility. The inventive step also covers other exemplary embodiments with other behaviour when experiencing a change in pressure. The volume relationships of pockets 2, 3 and bladders 4 can be adapted to various aircraft with different cabin pressure levels and different maximum operational altitudes. It is not mandatory for the bladders 4 to attain their maximum volume at the same pressure.

In a way that is adapted to the altitude, the altitude protection device provides the performance required to prevent hypoxemia. For example, up to an altitude of 5,500 metres above sea level, pressure breathing is increasingly supported in that the pressure in the abdominal cavity and the lungs is increased. From this altitude onwards, as the environmental pressure further drops, there is in addition direct compression of the torso region by way of the tension pocket 2 that acts as a fluid muscle or a linear actuator, and there is indirect compression in the entire region of the G-suit 1, which indirect compression spreads by way of the liquid-filled additionally tensioned veins 6. The environmental pressure, which is increased in the entire region of the G-suit 1, also acts against the decompression syndrome and, at altitudes from 19,200 metres above sea level (FL630) onward also against ebullism, the outgassing of bodily fluids. Certain aircraft attain maximum operational altitudes of up to 23,000 metres above sea level (FL750).

The bladders 4 can be designed as certified disposable bladders, which renders the altitude protection device extremely fault-resistant while also rendering it essentially maintenance-free.

FIG. 2 shows a first exemplary embodiment of a bladder 4. This bladder 4 is made from an elastic material, for example PU. The integrated knitted distance fabric 5 defines a minimum volume of air or gas that is taken up by the bladder 4 in its relaxed state, as shown in FIG. 2a. At a base altitude, for example at sea level, the pressure in the interior of the bladder corresponds to the external pressure while the bladder 4 is in its non-expanded and relaxed state, directly adjacent to the knitted distance fabric 5. FIG. 2b shows the same bladder 4 at higher altitude, i.e. at lower external pressure. The elastic bladder 4 is stretched and now takes up a volume that is larger than the minimum volume.

FIG. 3 shows a second exemplary embodiment of a bladder 4. The bladder 4 comprises an elastic middle bridge 7. The middle bridge 7 divides the bladder 4 into two intercommunicating chambers with the same pressure, each comprising a knitted distance fabric 5. The middle bridge 7 leads to a delayed expansion of the bladder 4 in the plane of the bridge. Depending on the thickness and the design, elastic elongation of the middle bridge 7 only commences from a definable ambient pressure. FIG. 3a shows the variant with a middle bridge 7 in the relaxed state at sea level pressure; FIG. 3b at commencement of elongation of the middle bridge 7; and FIG. 3c at maximum expansion of the bladder 4 with the middle bridge 7 elongated to the length of the diameter. One or several middle bridges 7 or other punctual or line-shaped elastic connecting parts of the top and bottom of the bladder 4 can be used in a targeted manner to cause expansion of the pressure pockets 3 and the tension pockets 2, which expansion is not directly proportional to the atmospheric pressure.

FIG. 4 shows a third exemplary embodiment of a bladder 4.

The bladder 4 is connected to an additional bladder 9 by way of an inelastic line 8. This additional bladder 9 has been placed into an inelastic additional pocket 10. This additional pocket 10 is connected in a non-positive manner to the line 8. In the additional bladder 9, as in the bladder 4, a minimum volume is defined by the knitted distance fabric S. The additional pocket 10 is situated outside the G-suit 1. The elasticity of the additional bladder 9 can exceed that of the bladder 4. As the ambient pressure drops, first the very elastic additional bladder 9 expands into the additional pocket 10. The volume of the bladder 4 is essentially unchanged. As soon as the additional bladder 9 has attained its maximum volume, i.e. as soon as it completely fills the additional pocket 10, any further pressure equalisation can only take place by way of expansion of the bladder 4. In other words the expansion is delayed and is greater than where there is no additional bladder 9 because a larger quantity of air becomes effective, namely the total quantity of gas that at the base height is contained in the bladders 4, 9 that are open in the knitted distance fabrics, as well as the gas that is contained in the line 8.

In a variant of this exemplary embodiment the additional volume merely comprises the line 8 which for example is a plastic pipe. Since the additional volume is defined in a fixed manner by a rigid inelastic pipe that under the influence of the forces and tensions encountered hardly undergoes any changes in cross section, the quantity of gas contained in the additional volume or in the additional volumes immediately and without any delay fully contributes to building up the tensile stress generated by the bladder 4. The additional volumes are placed on the outside of the G-suit 1 in such a way that they restrict and impede the mobility of the wearer as little as possible, even in their inflated state.

Apart from a simple and cost-effective manner of producing the altitude protection device according to the invention, said altitude protection device provides a great advantage in that there is no need for an additional garment, for example in the form of a jacket, which would unnecessarily constrain the wearer, and furthermore, in that from the point of view of energy and function said altitude protection device is independent and requires no connection lines whatsoever to the aircraft or to the ejection seat.

1. An altitude protection device for members of the crew of high-performance aircraft as a supplement to an acceleration protection suit according to the hydrostatic principle (G-suit (1)), which comprises a high-strength stretch-resistant woven textile fabric, comprising liquid-filled veins (6) that extend essentially along the entire length of the G-suit (1), characterised in that they comprise:
at least one tension pocket (2) made from a textile fabric with characteristics that are comparable to those of the G-suit (1), which tension pocket (2) at least along both edges that extend essentially so as to be perpendicular to the direction of tension is in a non-positive way connected to said G-suit (1) so that inflation of the pocket (2) leads to a reduction in the distance of these vertical connections;
in each case at least one gas-proof bladder (4) for each tension pocket (2), comprising an elastic plastic material;
at least one pressure pocket (3) made of a stretch-resistant textile fabric, which pressure pocket (3) is attached on the inside on the G-suit (1) along a line that is arranged so as to be perpendicular on the direction of tension so that inflation of the pressure pocket (3) does not result in any significant change in the circumferential tension of the G-suit (1); and
in each case at least one gas-proof bladder (4) for each pressure pocket (3), comprising an elastic plastic material.

2. The altitude protection device according to claim 1, characterised in that the bladders (4), of which there are at least two, comprise a knitted distance fabric (5), which allocates to them a predetermined minimum volume even under mechanical load.

3. The altitude protection device according to claim 2, characterised in that there is precisely one tension pocket (2) with one bladder (4), which tension pocket (2) is attached to the back piece of the G-suit (1) in such a way that it comes to rest between the veins (6) that extend on the rear of the G-suit (1), and that there are precisely two pressure pockets (3), each with a bladder (4), attached in the stomach region on the inside of the G-suit (1).

4. The altitude protection device according to any one of claims 1 to 3, characterised in that the tension pocket (2), of which there is at least one, at sea level is partly filled by the bladder (4) arranged inside it, and thus the bladder (4) when the ambient pressure decreases first fills in the volume of the tension pocket (2) before its expansion leads to a significant increase in the circumferential tension of the G-suit (1).

5. The altitude protection device according to any one of claims 2 to 4, characterised in that at least one bladder (4) comprises at least one bridge (7), which, when the bladder (4) is subjected to increased pressure, delays the expansion of said bladder (4) in the bridge plane.

6. The altitude protection device according to any one of claims 1 to 5, characterised in that the tension pocket (2), of which there is at least one, and the bladder (4) contained therein are dimensioned such that the tension pocket (2) significantly contributes to an increase in the circumferential tension of the G-suit (1) only from an atmospheric pressure that corresponds to an altitude of between 5,500 metres above sea level to 7,600 metres above seal level.

7. The altitude protection device according to any one of claims 1 to 6, characterised in that the tension pocket (2), of which there is at least one, and the pressure pocket (3) of which there is at least one, as well as the bladders (4) contained therein, are dimensioned such that the tension pockets (2) essentially attain their maximum volume from an atmospheric pressure which corresponds to the maximum operational altitude of the aircraft.

8. The altitude protection device according to any one of claims 1 to 7, characterised in that at least one bladder (4) is connected to an additional volume arranged outside the G-suit (1), wherein, when the ambient pressure drops, this additional volume remains constant from the point of reaching a predefined ambient pressure, and, furthermore, the quantity of gas contained therein essentially contributes entirely to building up tension in the bladder (4).

9. The altitude protection device according to claim 8, characterised in that the additional volume arranged outside the G-suit (1) comprises an additional elastic bladder (9) that is accommodated in an additional pocket (10) made from a stretch-resistant textile fabric, and comprises a line (8), wherein the line (8) connects the additional bladder (9) with the bladder (4).

10. The use of an altitude protection device according to any one of claims 1 to 9 as altitude protection for crew members of high-flying aircraft.
